(19) United States
(12) Patent Application Publication
(10) Pub. No.: US 2008/0009591 A1
(43) Pub. Date: Jan. 10, 2008

(54) Resin film for decorative sheet using thermoplastic elastomer and process for preparing the same

(75) Inventors: Jin-Woo Kim, Busan (KR); Young-Ho Cho, Busan (KR); Min-Ho Lee, Cheongju (KR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: LG Chem, Ltd., Seoul (KR)

(21) Appl. No.: 11/824,966

(22) Filed: Jul. 3, 2007

(30) Foreign Application Priority Data
Jul. 7, 2006 (KR) 10-2006-0063732

(51) Int. Cl. C08L 53/00

(52) U.S. Cl. 525/92 F

(57) ABSTRACT

The present invention relates to a resin film for a decorative sheet containing a thermoplastic polyether-ester elastomer (TPE-E) resin as a thermoplastic elastomer resin and a process for preparing the same.

### BACKGROUND OF THE INVENTION

This application claims the benefit of the filing date of Korean Patent Application No. 10-2006-0063732 filed on Jul. 7, 2006 in the Korean Intellectual Property Office, the disclosure of which is incorporated herein in its entirety by reference.

### FIELD OF THE INVENTION

The present invention relates to a resin film for a decorative sheet and a process for preparing the same. More particularly, the present invention relates to a resin film for a decorative sheet having excellent processability and adhesion, excellent impact strength and flexibility at low temperatures and excellent mechanical property in a wide range of temperatures, and to a process for preparing the resin film.

### DESCRIPTION OF THE RELATED ART

Conventional decorative sheets used as a surface decorative sheet for construction materials, furniture, unit bath, electric/electronic appliances, office appliances, and the like are, for example, composed of a substrate layer 50 including a metal plate, a plywood, a medium density fiberboard (MDF) or the like, an adhesive layer 40, a base film layer 30, a printed layer 20 and a surface film layer 10 including a biaxially stretched film or the like, as shown in FIG. 1.

Examples of a resin film used for the base film layer 30 include a polyolefin resin or a polyester resin, which contains polyethylene or polypropylene as its main component, in addition to a soft plasticized polyvinyl chloride resin having an excellent processability.

However, the resin film for a decorative sheet using polyvinyl chloride has problems in that the surface properties such as the contamination resistance and the solvent resistance are deteriorated, and the hydrochloric gas generation during burning or disposal, the environmental hormone generation by using a great amount of a plasticizer, and the like lead to maleficence. As a result, a demand for an environment friendly material that could substitute the polyvinyl chloride resin has been increased.

When the polyolefin resin is used alone, it is softer than the polyvinyl chloride resin, and generates bleaching during molding. In order to inhibit the bleaching, a rubber component is added to the polyolefin resin. However, this deteriorates heat resistance. The polyolefin has disadvantages in that the adhesion and the property of the polyolefin deteriorate when exposed to moisture.

The polyester resin such as polyethylene terephthalate or polybutylene terephthalate can solve the above problems. Moreover, the polyester resin has very excellent processability, embossing effect, solvent resistance and the like, and merits as an environment friendly material. However, the polyester resin has disadvantages in that the adhesion is low, the impact strength and flexibility is low at low temperatures, and difference in the property changes in a wide range of temperatures is large. Thus, means to solve these problems is necessary.

Japanese Patent Laid-Open Publication No. 1996-281880 discloses a polyester block copolymer laminated sheet comprising a sheet composed of a polyester block copolymer laminated with a natural paper, a synthetic paper or a polyester film.

The elastomer used in the Japanese Patent is a polyester block copolymer which is a different substance from a thermoplastic polyether-ester elastomer (TPE-E) used in the present invention. Specifically, in the case of a hard segment, the present invention uses dimethyl terephthalate and 1,4-butanediol, while the Japanese Patent uses polybutylene terephthalate. In the case of a soft segment, the present invention uses dimethyl terephthalate and polyoxyalkylene glycol having 3 to 10 carbon atoms, while the Japanese Patent uses an aromatic dicarboxylic acid and a long chain diol having 5 to 12 carbon atoms.

### SUMMARY OF THE INVENTION

Therefore, the present invention has been made in view of the above problems, and it is an object of the present invention to provide a resin film for a decorative sheet having excellent processability and adhesion, excellent impact strength and flexibility at low temperatures and excellent mechanical property in a wide range of temperatures, that can substitute the conventionally used polyvinyl chloride resin and solve the problems of the polyester resin which is used as a substitute for the polyvinyl chloride resin, and a method for producing the resin film.

In accordance with an aspect of the present invention, the above and other objects can be accomplished by the provision of a resin film for a decorative sheet containing a thermoplastic elastomer resin.

### BRIEF DESCRIPTION OF THE DRAWINGS

The above and other objects, features and other advantages of the present invention will be more clearly understood from the following detailed description taken in conjunction with the accompanying drawing(s), in which:

FIG. 1 is a cross-sectional view illustrating a decorative sheet.

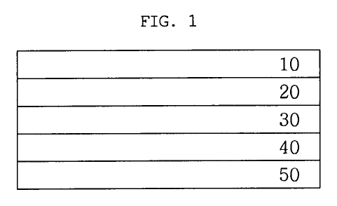

### DESCRIPTION OF THE PREFERRED EMBODIMENTS

The present invention will now be described in greater detail.

The thermoplastic elastomer resin used in the present invention is particularly preferably a thermoplastic polyether-ester elastomer (TPE-E) resin.

The thermoplastic polyether-ester elastomer resin has similar functions with the other elastomers in flexibility and elastic recovery. Meanwhile, it is superior to the other elastomers in the view of mechanical strength, heat resistance and weather resistance. Moreover, thermoplastic polyether-ester elastomer resin is convenient for the molding process in the same manner as general thermoplastic resins without carrying out the thionation process. Thereby, the thermoplastic polyether-ester elastomer resin can realize an appropriate flexibility and mechanical property by controlling the copolymer amount of a soft segment and via a typical polyester synthesis method.

Table 1 shows comparison of properties between TPE-E used preferably in the present invention and the other elastomers.

TABLE 1

| | | | | | | Urethane- |
|---|---|---|---|---|---|---|
| | | | Styrene-based | | Olefin- | based |
| Properties | | TPE-E | SBS | SEBS | based | (TPU) |
| Density | | 1.10-1.30 | 0.91-1.13 | 0.90-1.15 | 0.88-1.00 | 1.10-1.30 |
| Flexibility | | Δ | [symbol] | [symbol] | Δ-◯ | X-Δ |
| Mechanical Strength | | [symbol] | Δ | Δ-◯ | Δ | [symbol] |
| Low-temperature | | [symbol] | [symbol] | [symbol] | [symbol] | Δ-◯ |
| Performance | | | | | | |
| High-temperature | | [symbol] | X | Δ-◯ | ◯ | Δ |
| Performance | | | | | | |
| Electrical Properties | | ◯ | ◯- [symbol] | ◯- [symbol] | ◯- [symbol] | Δ |
| Weather Resistance | | ◯ | X | ◯- [symbol] | [symbol] | Δ-◯ |
| Oil Resistance | | ◯ | X | X-Δ | X-Δ | ◯ |
| Processability | Injection | ◯ | [symbol] | [symbol] | ◯ | Δ |
| | Extrusion | Δ-◯ | Δ-◯ | Δ-◯ | Δ-◯ | Δ |

[symbol]

: excellent,
◯: good,
Δ: normal,
X: bad
SBS: Styrene Butadiene Styrene Block Copolymer
SEBS: Styrene Ethylene Butylene Styrene Block Copolymer

The thermoplastic polyether-ester elastomer resin used in the present invention is composed of a soft segment and a hard segment.

The soft segment is composed of dimethyl terephthalate and a long chain (having 3 to 10 carbon atoms) polyoxyalkylene glycol. The hard segment is composed of dimethyl terephthalate and 1,4-butanediol.

Dimethyl terephthalate and 1,4-butanediol as the hard segment has an advantage in that the hard nature, which affects molecular chain rigidity and dimensional stability, is superior.

When dimethyl terephthalate is used as the soft segment instead of an aromatic compound, there is an advantage in that the soft nature including flexibility is more superior.

The resin film of the present invention may further comprise at least one of crystalline or non-crystalline polyester resin selected from polyethylene terephthalate (PET), polybutylene terephthalate (PBT), and a copolymer polyester resin having a part of acid or polyhydric alcohol components thereof substituted with other components, in addition to the thermoplastic polyether-ester elastomer resin.

The thermoplastic polyether-ester elastomer resin added with a crystalline or non-crystalline polyester resin may obtain effects of thermal stability during film processing, reduction in contraction percentage, improvement in surface gloss, increase in mechanical property, and the like.

When adding the polyester resin, the composition is preferably 50 to 70% by weight of the thermoplastic elastomer and 30 to 50% by weight of the polyester resin.

In addition, the present invention provides a process for preparing a resin film for a decorative sheet comprising the step of extruding, vacuum molding or calendering a thermoplastic elastomer resin into a film.

The present invention relates to a resin film for a decorative sheet, and particularly to a resin film for a decorative sheet having excellent processability, adhesion, impact strength and flexibility at low temperatures, mechanical property in a wide range of temperatures, elongation, adhesiveness with a surface layer, heat resistance, cold resistance, environmental resistance, recyclability, secondary processability, and the like.

The thermoplastic polyether-ester elastomer resin is used in the present invention to present the above characteristics. The thermoplastic polyether-ester elastomer resin is composed of a soft segment and a hard segment. The soft segment has a soft nature which affects the resin to be non-crystalline or crystalline. The hard segment has a hard nature which affects the molecular chain rigidity and dimensional stability. The characteristic of the elastomer is determined by a combination of these two segments.

That is, the elastomer has advantages of having excellent low-temperature performance, flexibility, processability and small difference in the property changes, since it has both soft nature, which affects the resin to be non-crystalline or crystalline, and hard nature, which affects the molecular chain rigidity and dimensional stability.

Further, the thermoplastic polyether-ester elastomer resin can be used with a polyester resin added thereto. The polyester resin used herein is at least one of crystalline or non-crystalline polyester resin selected from polyethylene terephthalate, polybutylene terephthalate, and a copolymer polyester resin having a part of acid or polyhydric alcohol components thereof substituted with other components.

Here, examples of polyvalent acids which can be substituted to the copolymer polyester resin in addition to terephthalic acid include aromatic dicarboxylic acids such as isophthalic acid, orthophthalic acid and 1,4-cyclohexane dicarboxylic acid, or aliphatic dicarboxylic acids such as adipic acid, sebacic acid and dodecanedionic acid. Moreover, examples of polyhydric alcohols which may be substituted to the copolymer polyester resin in addition to ethylene glycol include compounds represented by the general formula HO—(CH₂)n-OH.

Hereinafter, the present invention will be explained in more detail with reference to the following examples. However, these examples are given for the purpose of illustration and are not to be construed as limiting the scope of the invention.

### EXAMPLES

### Examples 1 to 3

### Production of Base Film Layers

Using the composition presented in Table 2, mixtures were prepared in pallets using a twin screw extruder, respectively. The mixtures in a pallet form blended with each individual composition were processed through an extruder respectively to produce base films having the thickness of 100 μm.

TPE-E was produced with a soft segment composed of 50% by weight of dimethyl terephthalate and 50% by weight of polyoxyalkylene glycol having 7 carbon atoms and a hard segment composed of 50% by weight of dimethyl terephthalate and 50% by weight of 1,4-butanediol.

### Comparative Examples 4 and 5

### Production of Conventional Base Film Layers

The conventional base film layers were prepared in the same manner as in the above Examples.

TABLE 2

| | Example | | | Comparative Example | |
|---|---|---|---|---|---|
| | (parts by weight) | | | (parts by weight) | |
| Classification | 1 | 2 | 3 | 4 | 5 |
| TPE-E | 100 | 60 | 60 | 0 | 0 |
| PET-based | | 40 | | 100 | |
| resin | | | | | |
| PBT-based | | | 40 | | 100 |
| resin | | | | | |
| R-101 | 4 | 4 | 4 | 4 | 4 |
| (pigment) | | | | | |

### TEST EXAMPLES

Samples prepared in the above Examples and Comparative Examples were tested for the following characteristics: the tensile strength (MD: machine direction, and TD: transverse direction), prolongation, heat resistance, Izod impact strength, and adhesion. The results are listed in Table 3. As shown in Table 3, the characteristics of the base film using TPE-E according to the present invention is superior to that of PET- or PBT-based base film.

TABLE 3

| Classi- | Example | | | Comparative Example | |
|---|---|---|---|---|---|
| fication | 1 | 2 | 3 | 4 | 5 |
| Tensile | MD: 400 | MD: 600 | MD: 550 | MD: 800 | MD: 590 |
| Strength | TD: 350 | TD: 500 | TD: 520 | TD: 850 | TD: 430 |
| (kgf/cm²) | | | | | |
| Prolongation | MD: 700 | MD: 350 | MD: 550 | MD: 120 | MD: 370 |
| (%) | TD: 650 | TD: 350 | TD: 500 | TD: 80 | TD: 260 |
| Heat | 1.7 | 1.5 | 1.5 | 1.0 | 1.2 |
| Resistance | | | | | |
| (ΔE) | | | | | |
| Izod Impact | 10 | 4 | 7 | 2 | 5 |
| Strength | | | | | |
| (−20° C.) | | | | | |
| Adhesion | 100 | 98 | 100 | 95 | 99 |
| (%) | | | | | |

Among the characteristics to be achieved in the present invention, the prolongation and the adhesion are particularly important. As confirmed in Table 3, the prolongation and the adhesion of the film consisting of TPE-E alone (Example 1) are the most excellent. However, the mechanical property is relatively insufficient. Therefore, the film which supplemented the strength by adding the polyester resin (PBT) in Example 3 is suitable for application to a product.

The resin film of the present invention comprises a thermoplastic elastomer which can substitute polyvinyl chloride resin used on a substrate such as a metal plate, and solve the problems of the polyester resin used as a substitute. Thereby, the resin film obtains effects of excellent impact strength and flexibility at low temperatures, increase in prolongation, high mechanical property in a wide range of temperatures, improvement in adhesiveness with a surface layer, convenience in processability, excellent recyclability, and the like.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A resin film for a decorative sheet comprising a thermoplastic polyether-ester elastomer (TPE-E) resin as a thermoplastic elastomer resin.

2. The resin film according to claim 1, wherein the thermoplastic polyether-ester elastomer (TPE-E) resin consists of a soft segment and a hard segment.

3. The resin film according to claim 2, wherein the soft segment consists of dimethyl terephthalate and a polyoxyalkylene glycol having 3 to 10 carbon atoms, and the hard segment consists of dimethyl terephthalate and 1,4-butanediol.

4. The resin film according to claim 1, wherein the resin film further comprises at least one of crystalline or non-crystalline polyester resin selected from the group consisting of polyethylene terephthalate, polybutylene terephthalate, and a copolymer polyester resin having a part of acid or polyhydric alcohol components thereof substituted with other components.

5. A process for preparing a resin film for a decorative sheet comprising the step of extruding, vacuum molding or calendering a thermoplastic elastomer resin into a film.
